(19) United States
(12) Patent Application Publication
(10) Pub. No.: US 2024/0218967 A1
(43) Pub. Date: Jul. 4, 2024

(54) DOOR HOOK ARRANGEMENT

(71) Applicant: Menz Industriedienstleistungs-GmbH, Zella-Mehlis OT Benshausen (DE)

(72) Inventor: Daniel MENZ, Schwarza (DE)

(21) Appl. No.: 18/402,514

(22) Filed: Jan. 2, 2024

(30) Foreign Application Priority Data
Jan. 4, 2023 (DE) 20 2023 100 020.7

(51) Int. Cl. F16M 13/02; A47G 7/04

(52) U.S. Cl. CPC F16M 13/022; A47G 7/04

(57) ABSTRACT

A door hook arrangement comprises a door hook, an angled support element which has a support element limb for arranging the support element on an upper side of a door leaf of a door and a further support element limb in parallel to the door leaf, having at least one recess through which a retaining strap is passed, the door hook being arranged suspended on the retaining strap, and an angled adjusting element for setting a distance between an adjusting element limb of the adjusting element extending parallel to the door leaf; wherein the support element limb has a plurality of through-holes formed in a row along its longitudinal axis; one or more hooks are formed on a surface side of a further adjusting element limb facing the support element limb, each hook engaging in a through-hole of the support element limb in each case, and the adjusting element is held on the support element or the adjusting element can be fastened to the support element limb at least in a force-locking manner by a screw passed through a through-hole of the support element limb and a recess in the further adjusting element limb; the adjusting element limb has a circular recess corresponding to a diameter of a screw-shaped fixing element, wherein the screw-shaped fixing element can be screwed into the circular recess and the support element can be fixed to the door leaf without play by the adjusting element and the screw-shaped fixing element.

### CROSS-REFERENCE TO RELATED APPLICATION

This application claims priority to German application no. 20 2023 100 020.7 filed on Jan. 4, 2023, which is hereby incorporated by reference in its entirety.

### BACKGROUND

### 1. Field of the Invention

The invention relates to a door hook for hanging a decorative element on a door with an angled support element, which has a limb for arranging the support element on an upper side of a door leaf of the door and a further limb running parallel to the door leaf with at least one recess through which a retaining strap is passed, a hook element for hanging the decorative element being arranged on the strap, and an angled adjustment element for setting a distance between a limb running parallel to the door leaf and the further limb of the support element.

### 2. Background Art

In general, a door hook is known for arrangement on a door, the door hook being provided for hanging up an item of clothing, a towel, etc.

A door hook for mounting on a door is known from the website https://www.amazon.de/dp/B088MCISJT/ (retrieved on Feb. 12, 2022 16:05). The door hook is provided for hanging a decorative element, in particular a door wreath, so that the decorative element is arranged in a region of a door leaf. The door hook has an angled support element for support on an upper side of the door leaf. A limb of the support element that can be arranged on the upper side has an elongated hole formed in the direction of its longitudinal axis. A screw with a metric full thread is passed through the elongated hole, with a screw head resting on the limb. The full thread of the screw engages in a hole corresponding to the diameter of the screw in an adjustment element arranged parallel to the door leaf. By means of the elongated hole and the screw, the adjusting element is slidably mounted on the limb of the support element so that a distance between a further limb of the support element running parallel to the door leaf and the adjusting element can be adjusted depending on the thickness of the door leaf. A recess is formed on the further limb, on which a flexible plastic strap and, at its free end, a hook element for holding the decorative element is arranged.

### SUMMARY

The object of the invention is to provide a novel door hook arrangement with a door hook for hanging a decorative element.

According to the invention, the object is achieved by a door hook arrangement which has the features specified in claim 1.

Advantageous embodiments of the invention are the subject of the subclaims.

A door hook arrangement comprises a door hook for hanging a decorative element, an item of clothing, a towel, etc. on a door and an angled support element which has a limb for arranging the support element on an upper side of a door leaf of the door and a further limb extending parallel to the door leaf with at least one recess through which a retaining strap is passed, the door hook being arranged suspended on the retaining strap. In addition, the door hook arrangement comprises an angled adjustment element for setting a distance between a further limb of the adjustment element running parallel to the door leaf and the further limb of the support element. According to the invention, it is provided that the limb of the support element has a plurality of through-holes formed in series along its longitudinal axis. On a surface side of the limb of the adjusting element facing the limb of the support element, one or more hooks are formed which engage in a selected through-hole of the limb of the support element in each case, so that the hook rests in sections on the limb of the support element and the adjusting element is held on the support element. Alternatively, the adjusting element can be fastened to the limb of the support element, at least in a force-locking manner, by a screw that passes through a selected through-hole in the limb of the support element and a recess in the limb of the adjusting element. In addition, the further limb of the adjusting element has a circular recess corresponding to a diameter of a screw-shaped fixing element, wherein the screw-shaped fixing element can be screwed into the circular recess and the support element can be fixed to the door leaf without play by the adjusting element and the screw-shaped fixing element.

Such a door hook arrangement enables a comparatively robust and play-free attachment of a decorative element, in particular a door wreath, to the outside of a door, in particular a house or apartment door. Such a door hook arrangement can be attached to almost any door, in particular a house or apartment door, due to its relatively low installation height in the area of the top of the door.

In one embodiment, the screw can be screwed to the recess in the limb of the adjusting element and/or to a screw nut. The adjustment element is held securely on the support element by the screw connection and unintentional loosening of the connection between the support element and the adjustment element can be largely ruled out.

In one embodiment, the screw-shaped fixing element is designed as a headless screw, a so called grub screw. The door hook arrangement can be fixed to the door, in particular firmly clamped, by the headless screw, which is screwed in the direction of the door leaf. The screw-shaped fixing element serves in particular as a locking screw.

In a further embodiment, a rubber buffer is attached to one end of the screw-shaped fixing element facing the door leaf, at least with a material bond. This protects the door leaf against scratching. In addition, noise development, in particular rattling, can be largely excluded if there should nevertheless be a gap between the fixing element and the door leaf. The rubber buffer, which deforms elastically under pressure, also makes it possible to screw the fixing element into the recess of the other limb with comparatively high force, so that the door hook arrangement attached to the door is held as securely as possible against slipping.

One version of the door hook arrangement provides for the door hook to have a further rubber buffer on a side facing the door leaf. This further rubber buffer is also provided to protect the door leaf against scratching by the door hook when the door hook moves relative to the door leaf, for example when the door is opened and closed and/or in windy conditions, and to prevent noise as far as possible when the door hook strikes the door leaf.

In a further development of the door hook arrangement, the further limb of the adjusting element has a further recess for fastening the retaining strap with the door hook or a further retaining strap with a further door hook. For example, by means of this recess in the further limb of the adjusting element, it is possible to arrange a decorative element hanging both on the outside of the door and on the inside of the door. It is also possible, for example due to design-related circumstances of the door and/or a door frame, to use only the recess of the further limb of the adjusting element for the hanging arrangement of a decorative element, for example a door wreath.

In a possible further development, the door hook and/or the further door hook have a plurality of openings for the passage of the retaining strap or a further retaining strap. The recesses can be used to adjust a length of the retaining strap or the further retaining strap and thus a height of the hanging decorative element in relation to the door, in particular the door leaf.

In another possible design, the retaining strap and/or the further retaining strap are made of plastic. For example, the respective retaining strap can be optimally cleaned due to the plastic, whereby robustness, for example in relation to weather conditions, can also be improved.

In addition, one version of the door hook arrangement provides that a loop for fixing a free end of the retaining strap and/or the further retaining strap is slidably arranged on the retaining strap and/or the further retaining strap. The free end is held by the loop so that the free end is fixed and thus fluttering around and the associated noise can be prevented as far as possible.

### BRIEF DESCRIPTION OF THE DRAWINGS

Examples of embodiments of the invention are explained in more detail below with reference to drawings.

FIG. 1 is a schematic side view of a door hook arrangement for hanging a decorative element,

FIG. 2 is a schematic perspective view of an exploded view of the door hook arrangement,

FIG. 3 is a schematic perspective view of the door hook arrangement in the assembled state,

FIG. 4 is a schematic top view of the door hook arrangement and

FIG. 5 is a schematic view of the door hook arrangement from below.

Corresponding parts are provided with the same reference signs in all figures.

### DETAILED DESCRIPTION OF SPECIFIC EMBODIMENTS

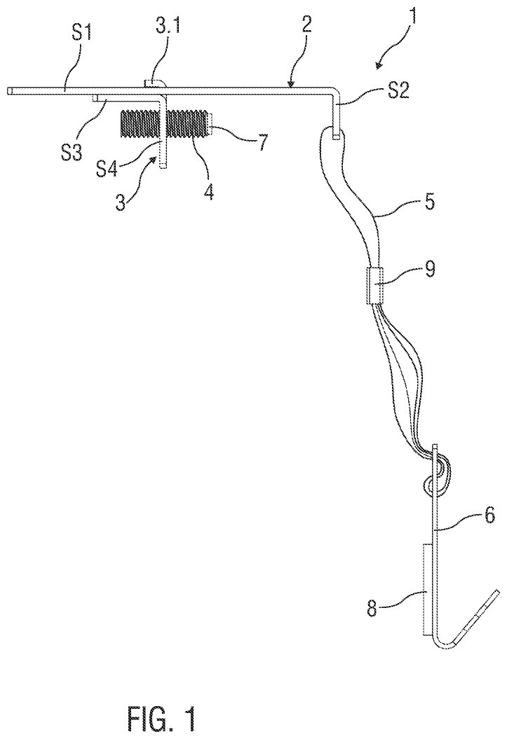

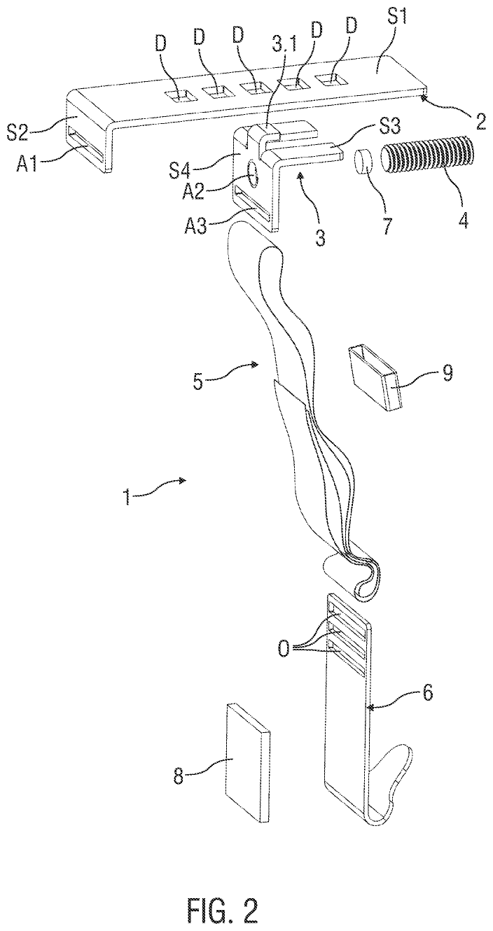

FIG. 1 shows a side view of a door hook arrangement 1 for hanging a decorative element not shown in detail, for example a door wreath, and FIG. 2 shows a perspective view of an exploded view of the door hook arrangement 1.

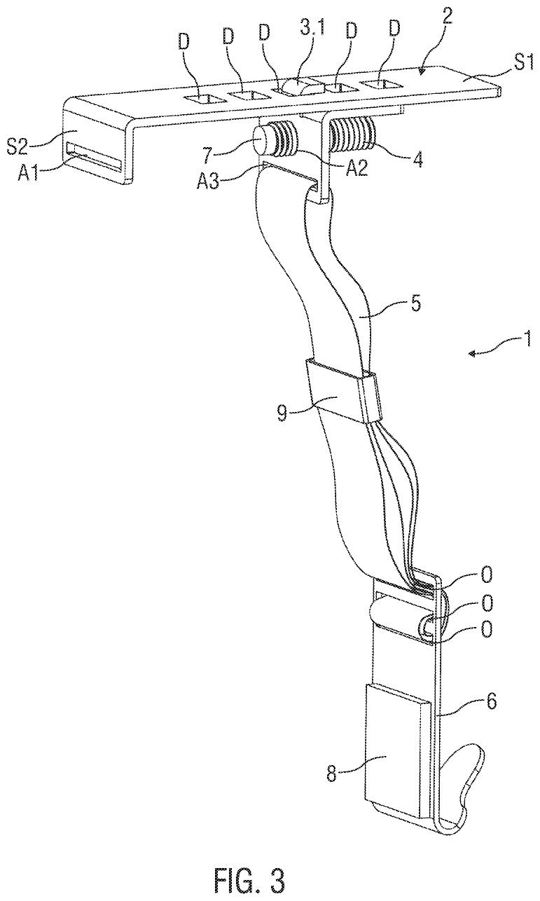

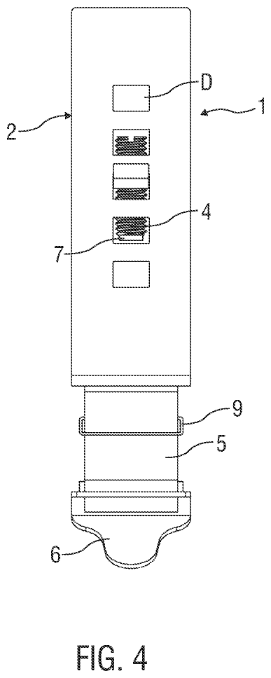

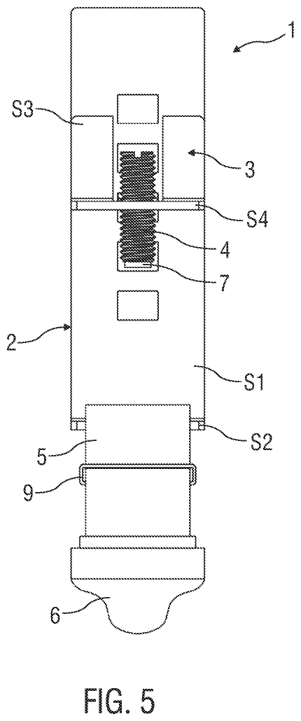

FIG. 3 shows a perspective view of the door hook arrangement 1 in the assembled state, FIG. 4 shows a top view of the door hook arrangement 1 and FIG. 5 shows a view of the door hook arrangement 1 from below.

The door hook arrangement 1 has a support element 2, an adjustment element 3, a fixing element 4, a retaining strap 5, a door hook 6, a rubber buffer 7, a further rubber buffer 8 and a loop 9.

In general, a door hook element is known, which is provided for arrangement on an upper side of a door leaf of a door, wherein a hook-shaped section of the door hook element is arranged on an outer side or an inner side of the door leaf, so that, for example, an item of clothing, a decorative element, etc. can be arranged hanging on the hook-shaped section.

A door hook arrangement 1 for hanging a decorative element, for example a door wreath, on a door, in particular on the outside of a house or apartment door, is also known from the prior art.

A door hook arrangement 1 is described below, which can be firmly fixed to a door leaf, in particular firmly clamped, so that the door hook arrangement 1 with the hanging decorative element is securely held.

The support element 2 is angled and has a limb S1, which is arranged at right angles to a further limb S2 running parallel to the door leaf.

The support element 2 rests with its limb S1 on the upper side of the door leaf, at least in sections, corresponding to the shape of the upper side of the door leaf. The limb S1 has a number of through-holes D in the direction of its longitudinal axis, five through-holes D according to the present embodiment in FIGS. 2 to 4. These through-holes D are arranged in a row in the direction of the longitudinal axis and have a predetermined shape, in particular a contour. In particular, these through-holes D are formed in a predetermined area of the limb S1.

The other limb S2 is essentially in full contact with the door leaf and has a recess A1. The recess A1 is slot-shaped and is provided for the passage of a retaining strap 5, on which the door hook 6 can be suspended. According to FIGS. 1, 4 and 5, the retaining strap 5 with the door hook 6 for hanging the decorative element is guided through the recess A1.

The adjusting element 3 is also angled and has a limb S3 running parallel to the limb S1 of the support element 2 and a further limb S4 running at right angles to the limb S3 and parallel to the door leaf.

A hook 3.1 is formed on the limb S3 of the adjusting element 3, which in sections forms an extension of the further limb S4 of the adjusting element 3. The hook 3.1 faces away from the limb S3.

The further limb S4, which is formed at right angles to the limb S3, has a circular recess A2, the diameter of which corresponds to the diameter of the screw-shaped fixing element 4. The screw-shaped fixing element 4 is in particular a headless screw, i.e. a so called grub screw. The rubber buffer 7 is arranged at a free end of the fixing element 4, in particular attached with a material connection.

In addition, the further limb S4 of the adjusting element 3 has a further recess A3, through which the retaining strap 5 or a further retaining strap not shown with a further door hook, also not shown, can be passed.

If a retaining strap 5 with door hooks 6 is arranged on the support element 2 and the adjusting element 3 of the door hook arrangement 1, a respective decorative element, for example a door wreath, can be arranged hanging on both the outside and the inside of the door leaf.

The retaining strap 5 is made of plastic, for example, and is arranged in several layers depending on its length and a desired height of the decorative element hanging on the door leaf. A free end of the retaining strap 5 is fixed to the retaining strap 5 by the loop 9.

The door hook 6 has a plurality of slot-shaped feed-through openings O. According to the present embodiment in FIGS. 2 and 3, three slot-shaped feed-through openings O are provided in the door hook 6. One free end is bent in the shape of a hook so that the decorative element can be suspended from it. The further rubber buffer 8 is arranged on a side of the door hook 6 facing the door leaf, in particular to protect the door leaf against scratching when the door hook 6 swings with a decorative element hanging on it, for example when the door is opened and closed and/or due to wind. In addition, the further rubber buffer 8 largely prevents direct contact between the door hook 6 and the door leaf, so that noise can also be largely avoided when the door hook 6 strikes the door leaf.

When mounting the door hook arrangement 1 on a door leaf, the limb S1 of the support element 2 is first arranged on the upper side of the door leaf in such a way that the other limb S2 lies flat against the door leaf.

Depending on the thickness of the door leaf, a through-hole D is selected in the limb S1, through which the hook 3.1 of the adjusting element 3 is guided. The hook 3.1 rests on a surface side of the limb S1 of the support element 2 and points in a direction away from the door leaf. In particular, the through hole D is selected in the limb S1 of the support element 2, which is arranged comparatively close to the door leaf.

In an alternative embodiment, no hook 3.1 is formed on the limb S3 of the adjusting element 3 and the adjusting element 3 is attached to the support element 2 by a screw connection. For this purpose, a screw not shown in detail is guided through a selected through-hole D in the limb S1 of the support element 2.

The limb S3 of the adjusting element 3 has a recess along its longitudinal axis, through which the screw is also passed, so that a longitudinal axis of the screw runs essentially parallel to the door leaf.

The screw can be screwed to the limb S3, in particular to an edge area that partially encloses the recess, and/or to a screw nut. In this case, a screw head rests on the limb S1 of the support element 2, whereas the screw nut rests on an underside of the limb S3 of the adjustment element 3 when screwed in.

The fixing element 4, i.e. the headless screw, is then screwed into the circular recess A2 of the further limb S4 of the adjusting element 3 until the rubber buffer 7 is elastically deformed and rests against the door leaf. The door hook arrangement 1 is thus attached to the door leaf, in particular clamped.

In one embodiment, two such door hook arrangements 1, which are arranged at a predetermined distance from each other, can be attached to a door leaf. A hook strip can then be hung on the two spaced-apart door hooks 6, the length of which essentially corresponds to the distance between the two door hooks 6.

The hook strip has several hook elements so that several decorative elements, items of clothing and/or towels can be hung, in particular next to each other.

### LIST OF REFERENCE SIGNS

1 door hook arrangement
2 support element
3 adjustment element
3.1 hook
4 fixing element
retaining strap
6 door hook
7 rubber buffer
8 further rubber buffer
9 loop
A1 recess
A2 circular recess
A3 further recess
D through hole
O feed-through opening
S1, S3 limb
S2, S4 further limb

What is claimed is:

1. A door hook arrangement, comprising:
a door hook for hanging a decorative element on a door,
an angled support element which has a support element limb for arranging the support element on an upper side of a door leaf of the door and a further support element limb running parallel to the door leaf and having at least one recess through which a retaining strap is passed, the door hook being arranged suspended on the retaining strap, and
an angled adjusting element for setting a distance between an adjusting element limb of the adjusting element extending parallel to the door leaf and the further support element limb of the support element,
wherein
the support element limb of the support element has a plurality of through-holes formed in a row along its longitudinal axis,
one or more hooks are formed on a surface side of a further adjusting element limb of the adjusting element facing the support element limb of the support element, each hook engaging in a selected through-hole of the support element limb of the support element in each case, so that the hook rests in sections on the support element limb of the support element and the adjusting element is held on the support element or the adjusting element can be fastened to the support element limb of the support element at least in a force-locking manner by a screw passed through a selected through-hole of the support element limb of the support element and a recess in the further adjusting element limb of the adjusting element,
the adjusting element limb of the adjusting element has a circular recess corresponding to a diameter of a screw-shaped fixing element, wherein the screw-shaped fixing element can be screwed into the circular recess and the support element can be fixed to the door leaf without play by the adjusting element and the screw-shaped fixing element.

2. The door hook arrangement according to claim 1,
wherein the screw can be screwed to the recess of the adjusting element limb of the adjusting element and/or to a screw nut.

3. The door hook arrangement according to claim 1,
wherein the helical fixing element is designed as a headless screw.

4. The door hook arrangement according to claim 1,
wherein a rubber buffer is attached to one end of the screw-shaped fixing element facing the door leaf, at least with a material bond.

5. The door hook arrangement according to claim 1,
wherein the door hook has a further rubber buffer on a side facing the door leaf.

6. The door hook arrangement according to claim 1,
wherein the adjusting element limb of the adjusting element has a further recess for fastening the retaining strap with the door hook or for fastening a further retaining strap with a further door hook.

7. The door hook arrangement according to claim 6,
wherein the door hook and/or the further door hook have or has a plurality of through-openings for the passage of the retaining strap or the further retaining strap.

8. The door hook arrangement according to claim 6,
wherein the retaining strap and/or the further retaining strap are or is made of plastic.

9. The door hook arrangement according to claim 6,
wherein a loop for fixing a free end of the retaining strap and/or the further retaining strap is slidably arranged on the retaining strap and/or the further retaining strap.
